(19) United States
(12) Patent Application Publication
(10) Pub. No.: US 2025/0056365 A1
(43) Pub. Date: Feb. 13, 2025

(54) CELL RESELECTION REQUIREMENTS WITH SATELLITE PRIORITIZATION

(71) Applicant: Nokia Technologies Oy, Espoo (FI)

(72) Inventors: Rafhael MEDEIROS DE AMORIM, Aalborg (DK); Mads LAURIDSEN, Gistrup (DK)

(21) Appl. No.: 18/786,994

(22) Filed: Jul. 29, 2024

(30) Foreign Application Priority Data
Aug. 8, 2023 (FI) 20235879

(51) Int. Cl. H04W 36/36; H04B 7/185; H04W 72/56

(52) U.S. Cl. CPC H04W 36/36; H04B 7/1851; H04W 72/56

(57) ABSTRACT

Example embodiments of the present disclosure generally relate to methods, devices, apparatuses and computer readable storage medium for cell reselection requirements with satellite prioritization. The method includes determining at least one first candidate satellite currently available for a neighbor cell measurement; determining at least one target satellite to be measured in the neighbor cell measurement at least based on the number of the at least one first candidate satellite and respective priorities of the at least one first candidate satellite, or at least one second candidate satellite that is becoming available within a first time interval; and performing the neighbor cell measurement on the at least one target satellite.

### FIELDS

Various example embodiments of the present disclosure generally relate to the field of telecommunication and in particular, to methods, devices, apparatuses and computer readable storage medium for cell reselection requirements with satellite prioritization.

### BACKGROUND

Internet of Things (IoT) and eMTC enhanced Machine-Type Communication (eMTC) are expected to be low-cost devices, with limited capabilities and to be deployed in larger numbers (for example, in a network of sensors). One important aspect of this type of devices is that for most of the applications, their battery is expected to last for very long time (months to years). To obtain that, the UE has to see optimizations in their air interface to limit the energy consumption.

### SUMMARY

In a first aspect of the present disclosure, there is provided a first apparatus. The first apparatus comprises at least one processor; and at least one memory storing instructions that, when executed by the at least one processor, cause the first apparatus at least to: determine at least one first candidate satellite currently available for a neighbor cell measurement; determine at least one target satellite to be measured in the neighbor cell measurement at least based on the number of the at least one first candidate satellite and respective priorities of the at least one first candidate satellite, or at least one second candidate satellite that is becoming available within a first time interval; and perform the neighbor cell measurement on the at least one target satellite.

In a second aspect of the present disclosure, there is provided a method. The method comprises: determining at least one first candidate satellite currently available for a neighbor cell measurement; determining at least one target satellite to be measured in the neighbor cell measurement at least based on the number of the at least one first candidate satellite and respective priorities of the at least one first candidate satellite, or at least one second candidate satellite that is becoming available within a first time interval; and performing the neighbor cell measurement on the at least one target satellite.

In a third aspect of the present disclosure, there is provided a first apparatus. The first apparatus comprises means for determining at least one first candidate satellite currently available for a neighbor cell measurement; means for determining at least one target satellite to be measured in the neighbor cell measurement at least based on the number of the at least one first candidate satellite and respective priorities of the at least one first candidate satellite, or at least one second candidate satellite that is becoming available within a first time interval; and means for performing the neighbor cell measurement on the at least one target satellite.

In a fourth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a flowchart of a method implemented at a first apparatus according to some example embodiments of the present disclosure;

FIG. 3 illustrates a flowchart of a method implemented at a first device according to some example embodiments of the present disclosure;

FIG. 4 illustrates a simplified block diagram of a device that is suitable for implementing example embodiments of the present disclosure; and

FIG. 5 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), enhanced Machine Type Communication (cMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (cNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

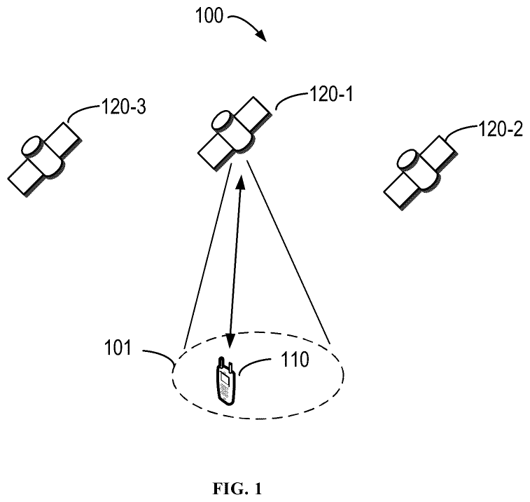

FIG. 1 illustrates an example communication environment 100 in which example embodiments of the present disclosure can be implemented. As shown in FIG. 1, the communication network 100 may comprise a first apparatus 110 which may be, for example, a terminal device. In some example embodiments, the terminal de vice may also be discussed as a UE.

The communication network 100 may further comprise network devices 120-1, 120-2, 120-3. In some example embodiments, the network device may be discussed as a BS, a gNB, or an eNB. As shown in FIG. 1, the network devices 120-1, 120-2, 120-3 may be hosted in a satellite (regenerative architecture) or relayed through a satellite (transparent architecture).

In some scenarios, the first apparatus 110 may communicate with the network device 120-1 (which may also be referred to as satellite 120-1 below) within a coverage 101 of the network device 120-1, for example, the geographical area of the first apparatus 110 is served by a satellite beam or cell from the network device 120-1. For purpose of discussion, the coverage 101 is also referred to a serving cell 101, which may be, for instance, a non-terrestrial network cell.

In some scenarios, the network device 120-2 and the network device 120-3 may be considered as neighboring network devices (which may also be referred to as satellite 120-2 and satellite 120-3 below, respectively). Correspondingly, the coverage of the network device 120-2 and the coverage of the network device 120-3 may be considered as neighboring cells.

The communication network 100 may be a Non-terrestrial network (NTN) network or a network with NTN structure. There may be different types of satellite orbits that have been studied for NTN access including Low Earth Orbit (LEO) satellites which orbit at approximately 600 km above the Earth. It is to be understood that any other suitable type of satellites may also be used for the NTN structure.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As descried above, IoT and eMTC devices are expected to be low cost devices. One important aspect of this type of devices is that for most of the applications, their battery is expected to last for very long time (months to years). To obtain that, the UE has to see optimizations in their air interface to limit the energy consumption.

A UE in Idle mode is required to perform frequent measurements, both in the serving and neighbor cells, to guarantee that the UE can perform cell reselection to a better cell, when the radio quality is degrading for example to be able to monitor for paging and to initiate mobile-originated traffic.

In NTN, when LEO (low-earth orbit) satellites are used the high speed of the satellites (up to 7.5 km/s relative to Earth) leads to a very high frequency doppler shift observed by the UE in DL signal. The values of frequency doppler offset in NTN is much higher than the ones observed in terrestrial networks, up to +24 ppm (parts per million) and with an absolute instantaneous variation up to 0.27 ppm/s.

With respect to FIG. 1, assuming the three LEO satellites (the network devices 120-1, 120-2, 120-3) in FIG. 1 are providing coverage for the same DL frequencies, at the UE side (i.e., the first apparatus 110), the signal incoming from the three satellites will be seen at different center frequencies by the UE.

Because of this, in NTN, it was agreed that the UE has to be provided the information about the neighbor satellites, such that the UE can retune its receivers to appropriately and timely collect the measurements about neighboring satellites. It is important to note that this is captured in the demodulation requirements for the UE, where the DL shift is modelled as only residual DL doppler, with most part of the doppler compensation assumed to be performed at the UE side. Related agreements are listed as below:

TABLE 1
Issue: Frequency and timing drift modelling
Agreement:

Do not consider Doppler shift for feeder link for DL
Do not consider the frequency Drift
Do not define sampling offset model
The maximum Doppler shift is residual frequency offset, i.e., 0.1 ppm.

Moreover, it was established that the mobility requirements will only apply for UEs when information about the neighbor cells are specifically conveyed to the UE. Related agreements are listed as below:

TABLE 2
Agreements

When no satellite assistance information is provided
For NGSO case the neighbor cell measurements requirements
are not applicable
FFS on neighbor cell measurements requirements for GSO case
FFS whether to apply intra-frequency neighbor cell measurements
requirements for GEO case

Regarding the additional information to be conveyed to the first apparatus 110 for it to be capable of retuning, related agreements are listed as below:

TABLE 3
Agreements:

| | |
|---|---|
| 1. | New system information block xx (SIBxx) is introduced to broadcast the neighbor |
| | cell/satellite information. |

Agreements via email - from offline 114:

| | |
|---|---|
| 1. | Common Timing Advance (TA) parameters are broadcast as assistance information for |
| | neighbor cell measurements. |
| 2. | Kmac is broadcast as neighbor cell assistance information. |
| 3. | For moving cell, the UE can derive the trajectory of serving cell with rough accuracy based |
| | on serving satellite ephemeris and epochTime, with the assumption that the serving cell |
| | reference location broadcast by the network is the one at Epoch time (like in NR-NTN) |

Agreements online:

| | |
|---|---|
| 1. | Introduce satellite ID for the satellite in a list in new SIB-xx. FFS on the |
| | details of the new information element (IE) |
| 2. | For eMTC NTN, for fixed cell, location-based measurement initiation can also be used |
| | in RRC_IDLE for cell re-selection purposes (like in NR-NTN) |
| 3. | For eMTC NTN, for moving cell, location-based measurement initiation can also be used |
| | in RRC_IDLE for cell re-selection purposes (like in NR-NTN). FFS whether to consider |
| | solution that does not require UE to update the GNSS for this same as in connected mode |
| 4. | SIB3 is extended to include the reference location and distanceThresh |

Furthermore, some additional agreements were made as shown below:

TABLE 4
Agreements:

| | |
|---|---|
| 1. | For earth-fixed cells, introduce t-ServiceStart for neighbor cells. If UE is aware of the t- |
| | ServiceStart of the neighbour cell then may be used (up to UE implementation) to |
| | determine when to start measurements of that neighbor cell |
| 2. | If the serving cell t-service expires, stop T310 (if running) and start T311 (i.e. perform cell |
| | search and re-establishment without attempting to recover on the current cell for the |
| | duration of T310). FFS on discontinuous coverage |
| 3. | The distance between the UE and a second reference location (e.g. within a neighbour cell) |
| | is not taken into account. |
| 4. | R18 location and time based trigger for measurements (for connected mode and for idle) |
| | apply to both NB-IoT and eMTC. |

The current specifications establish requirements for how fast the UE has to measure, detect and evaluate neighbor cells, which may be listed as below (similar specification can be found for cMTC UE as well).

TABLE 5
Measurements of intra-frequency NB-IoT cells for UE category NB1 in normal coverage

The UE shall be able to identify new intra-frequency cells and perform NRSRP measurements
of identified intra-frequency cells without an explicit intra-frequency neighbour list containing
physical layer cell identities.
The UE shall be able to evaluate whether a newly detectable intra-frequency cell meets the
reselection criteria within Kₛₐₜₑₗₗᵢₜₑ*T_{detect, NB}_{_{—}}_{Intra}_{_{—}}_{NC} when Treselection = 0. An intra frequency
cell is considered to be detectable according to NRSRP, NRSRP Ês/Iot, NSCH_RP and NSCH
Ês/Iot defined in Annex B.1.4 for a corresponding Band.
The UE shall measure NRSRP at least every Kₛₐₜₑₗₗᵢₜₑ*T_{measure, NB}_{_{—}}_{Intra}_{_{—}}_{NC} for intra-frequency cells
that are identified and measured according to the measurement rules.
The UE shall filter NRSRP measurements of each measured intra-frequency cell using at least
2 measurements. Within the set of measurements used for the filtering, at least two
measurements shall be spaced by at least Kₛₐₜₑₗₗᵢₜₑ*T_{measure, NB}_{_{—}}_{Intra-NC}/2
The UE shall not consider an NB-IoT neighbour cell in cell reselection if it is indicated as not
allowed in the measurement control system information of the serving NB-IoT cell.
For an intra-frequency cell that has been already detected, but that has not been reselected to,
the filtering shall be such that the UE shall be capable of evaluating that the intra-frequency
cell has met reselection criterion defined [1] within Kₛₐₜₑₗₗᵢₜₑ*T_{evaluate, NB}_{_{—}}_{intra-NC} When T_{reselection} =
0, provided that the cell is at least XdB better ranked, where ‘X’ is specified in Table 4.6A.2.4-
3. When evaluating cells for reselection, the side conditions for NRSRP, NRSRP Ês/Iot,
NSCH_RP and NSCH Ês/Iot apply to both serving and non-serving NB-IoT intra-frequency
cells.
The paraemter Kₛₐₜₑₗₗᵢₜₑ is the scaling factor for measurements correspond to multiple NGSO
satellites. K_{satellite =} TBD
If T_{reselection} timer has a non zero value and the intra-frequency cell is better ranked than the
serving NB-IoT cell, the UE shall evaluate this intra-frequency cell for the T_{reselection} time. If
this cell remains better ranked within this duration, then the UE shall reselect that cell.
For UE not configured with eDRX_IDLE cycle, T_{detect, NB}_{_{—}}_{Intra}_{_{—}}_{NC}, T _{measure, NB}_{_{—}}_{Intra}_{_{—}}_{NC} and
T_{evaluate, NB}_{_{—}}ᵢₙₜᵣₐ_{_{—}}_{NC} are specified in Table 4.6A.2.2-1. For UE configured with eDRX_IDLE cycle,
T_{detect, NB}_{_{—}}_{Intra-NC}, T_{measure, NB}_{_{—}}_{Intra}_{_{—}}_{NC} and T_{evaluate, NB}_{_{—}}_{intra-NC} are specified in Table 4.6A.2.2-2,
where the requirements apply provided that the serving NB-IoT cell is configured with
eDRX_IDLE and is the same in all PTWs during any of T_{detect, NB}_{_{—}}_{Intra}_{_{—}}_{NC}, T_{measure, NB}_{_{—}}_{Intra}_{_{—}}_{NC} and
T_{evaluate, NB}_{_{—}}ᵢₙₜᵣₐ_{_{—}}_{NC} when multiple PTWs are used.

To limit the power consumption of the IoT devices, several enhancements were made in the cell reselection procedure to minimize first apparatus 110 activity.

For example, it has been recently agreed that IoT/eMTC device (i.e., UE) in NTN is required to measure a minimum of 2 satellites (one serving and one neighbor satellite). Furthermore, capability to measure more than 2 devices are optional to the first apparatus 110 implementation. Related agreements are listed as below:

TABLE 6
Issue: Measurement capabilities on number of NGSO satellites

The minimum of the UE capability on the total number of the NGSO satellites
across the layers is [2].
For NB in IDLE and M1 in both IDLE and
is [2] including serving LEO satellite.dsa
for inter-frequency carrier, the number of target satellites UE needs to
monitor per carrier is [2] if one of the target satellites include the UE serving
satellite; the number of target satellites UE needs to monitor is [1] otherwise.

Furthermore, the two satellites are not necessary the same for every frequency layer. Related agreements are listed as below:

TABLE 7
Issue: Measurement capabilities on number of NGSO satellites
Agreements

Clarify that the sets of neighbor satellites for inter-frequency measurements that
the UE shall be capable to measure in each frequency layer in NGSO scenarios
are not necessary the same

It was also discussed that the UE might be configured with multiple neighbor cell satellites. In this case, it is important for the UE to know which of the multiple satellites must be chosen for measurements, as the UE is required to detect neighbor cells that are above a certain threshold of received power level within a certain time window and the UE will be levied of this requirement for the “not chosen” satellites. The choice cannot be at random, as the UE is required to detect a cell from the selected source satellite within a given period of time (if the cell is at detectable level), and the UE would NOT be required to do the same towards the neighbor cells from a different target satellite.

Therefore, some example embodiments of the present disclosure propose a mechanism for cell reselection with satellite prioritization. In this solution, the first apparatus 110 determines at least one first candidate satellite currently available for a neighbor cell measurement. Then the first apparatus 110 determines at least one target satellite to be measured in the neighbor cell measurement at least based on the number of the at least one first candidate satellite and respective priorities either of the at least one first candidate satellite or of at least one second candidate satellite that is becoming available within a time interval. Then the first apparatus 110 performs the neighbor cell measurement on the at least one target satellite.

Based on the solution, the first apparatus 110 may prioritize satellites first by their availability when the neighbor cell measurements are triggered. In this way, the number of satellites to be measured in the neighbor cell measurements can be limited and therefore the power saving of the UE may be further enhanced.

Example embodiments of the present disclosure will be described in detail below with reference to the accompanying drawings.

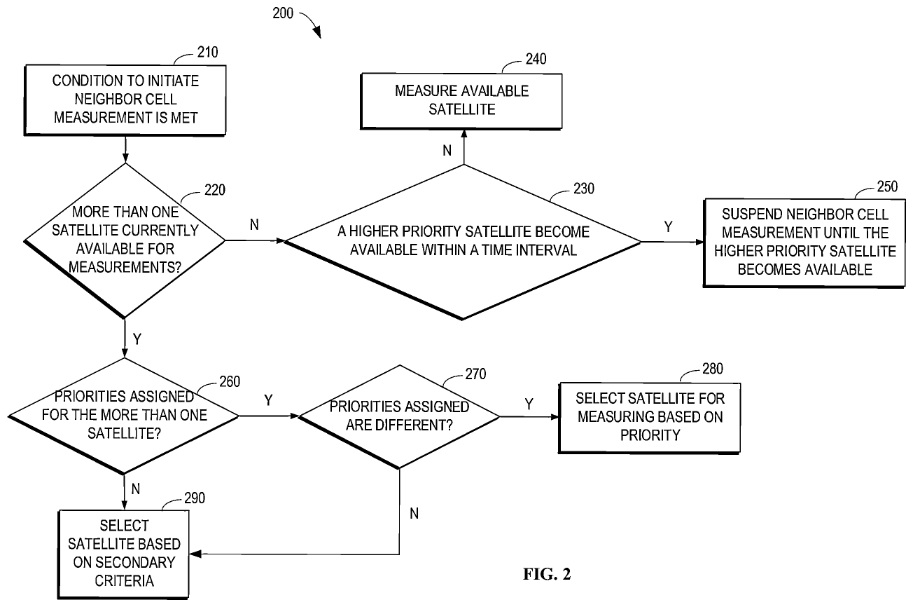

FIG. 2 illustrates a flowchart of a method implemented at a first apparatus 110 according to some example embodiments of the present disclosure. For the purpose of discussion, the process 200 will be described from the perspective of the first apparatus 110 in FIG. 1.

In NTN, the first apparatus 110 in Radio Resource Control (RRC) idle state may be configured with or receives the information about more than one different neighbor satellite for one or more of its frequency layers (e.g., in system information).

The first apparatus 110 in RRC IDLE may continue performing serving cell measurements, until the criteria for performing neighbor cell measurements is met. At block 210, if the first apparatus 110 determines that criteria for initiating a neighbor cell measurement is met, the first apparatus 110 may start measuring neighbor cells. For example, the criteria for performing neighbor cell measurements might be the power of the serving cell signal or the location of the different satellites conveyed by the first apparatus 110. In some embodiments, measurements towards neighbor cell satellites might be triggered at different points in time.

Then the first apparatus 110 may determine at least one first candidate satellite currently available for a neighbor cell measurement. At block 220, the first apparatus 110 may determine whether more than one candidate satellite is currently available for the neighbor cell measurement (hereinafter the candidate satellite currently available may be referred to as a first candidate satellite). The availability information may be the estimation of a coverage in the location of the first apparatus 110, provided via footprint information broadcast by the serving cell and/or the initial point in time where a neighbor satellite may start to provide coverage in a region.

In some example embodiments, if only one first candidate satellite (such as the satellite 120-2 as shown in FIG. 1) is currently available for the neighbor cell measurement, at block 230, the first apparatus 110 may determine whether one or more other candidate satellites (such as the satellite 120-3 as shown in FIG. 1, hereinafter may be called as second candidate satellites), which have priorities higher than the priority of the first candidate satellite currently available, are becoming available within a first time interval. In some embodiments, the first time interval may be referred to as a time window T detect and may be configured by the network or defined in the specification.

If so, at block 250, the first apparatus 110 may suspend the neighbor cell measurement until the at least one second candidate satellite becomes available. That is, the first apparatus 110 may not start measuring a neighbor satellite if it cannot complete a detection before a new higher priority satellite becomes available.

If no second candidate satellite having a higher priority within the first time interval, at block 240, the first apparatus 110 may perform measurement on the only one candidate satellite currently available.

If the first apparatus 110 may determine more than one candidate satellite (such as satellites 120-2 and 120-3 as shown in FIG. 1) is currently available for the neighbor cell measurement, at block 260, the first apparatus 110 may determine whether respective priorities are assigned to the plurality of candidate satellites. If respective priorities are assigned to the plurality of candidate satellites, at block 270, the first apparatus 110 may further determine whether the respective priorities assigned to the plurality of candidate satellites are different. The case where the respective priorities are different may mean no “ties” between those candidate satellites.

In some embodiments, the priorities of the plurality of candidate satellites may be explicitly indicated, e.g., by signaling a parameter defining the priority as an absolute value. In some other embodiments, the priorities of the more than two candidate satellite may be implicitly assigned, e.g., by order presented in the list of the configuration.

If the first apparatus 110 determines respective priorities assigned to the plurality of candidate satellites are different, at block 280, the first apparatus 110 may select at least one target satellites, to be measured on the neighbor cell measurement, from the plurality of candidate satellites based on a ranking of the respective priorities. For example, one or more candidate satellites having highest priority may be selected.

If the first apparatus 110 determines no priorities are assigned to the plurality of candidate satellites or at least two candidate satellites in the plurality of candidate satellites have a highest and equal priority, as an option, the first apparatus 110 may determine, from the plurality of candidate satellites, one or more candidate satellites associated with a cell having a higher priority than cells on the other candidate satellites. Then the first apparatus 110 may perform the neighbor cell measurement on the one or more candidate satellites associated with the cell having the higher priority.

For example, the first apparatus 110 may derive the association between respective cells and the plurality of candidate satellites, e.g., by the physical cell identifier (PCI) list per satellite.

If the first apparatus 110 determines no priorities are assigned to the plurality of candidate satellites or at least two candidate satellites in the plurality of candidate satellites have a highest and equal priority, as an option, at block 290, the first apparatus 110 select the at least one target satellite to be measured based on other information, which may also be called as secondary criteria. For example, the secondary criteria may be defined in specification and/or configured by the network device.

For example, the secondary criteria may comprise location information of the first apparatus 110 and the plurality of first candidate satellites, respective available frequencies in each of the plurality of first candidate satellites, and/or respective periods within which the plurality of first candidate satellites is available for the first apparatus 110.

In some embodiments, the location information of the first apparatus 110 and the plurality of first candidate satellites may refer to distances between the first apparatus 110 and the plurality of first candidate satellites. For example, the first apparatus 110 may choose the satellite which is closest to the first apparatus 110.

Alternatively, instead of the satellite location, the first apparatus 110 may check the distance to one or more reference locations of the satellite/cell footprint provided via network signaling.

Furthermore, the location information of the first apparatus 110 and the plurality of first candidate satellites may refer to movement directions of the plurality of first candidate satellites with respect to the first apparatus 110. Therefore, the selection may also be performed in “the direction of movement” where the first apparatus 110 selects the satellite which is moving most favorably to the over time of the first apparatus 110 e.g., approaching the first apparatus 110 instead of distancing it.

It is also possible that the first apparatus 110 may also consider its own movement/trajectory if it is known.

Moreover, the first apparatus 110 may determine respective locations of the first apparatus and the plurality of first candidate satellites at the end of a time interval e.g., T_{detect}. This criterion is similar to the criteria above, however, instead of using the satellite, which is currently closer to the first apparatus 110, the first apparatus 110 may choose the satellite that will be the closest one in the future (for example at the end of the T_{detect} window). In this sense, the first apparatus 110 may benefit from the knowledge of the direction of movement of the first apparatus 110 and the satellite within the T_{detect} window.

If the secondary criteria refer to respective available frequencies in each of the plurality of first candidate satellites, the first apparatus 110 may choose to measure the satellite which provides more frequency layers of coverage. In addition, assuming the set of frequency layers across satellites are different, the first apparatus 110 may be allowed to choose to measure, in each frequency layer, the satellite which is broadcasting the frequency layer that it has high priority for the first apparatus 110.

If the secondary criteria refer to respective periods within which the plurality of first candidate satellites is available for the first apparatus, i.e., time of stay, the first apparatus 110 may choose the satellite that will be available for longer periods of time. This decision might be based, for instance, in the estimation of footprint coverage and satellite movement at the location of first apparatus 110 and/or based on the broadcasting of the parameter t-service & t-service-start for the different satellites. The first apparatus 110 may also consider its own movement/trajectory if it is known.

In some other embodiments, it might be the case that the first apparatus 110 selects a satellite for neighbor cell measurements and after some (long) time, a different neighbor satellite with higher priority becomes available, or a neighbor satellite with equal priority becomes higher ranked according to one of the secondary criteria. In this case the first apparatus 110 may follows the re-switching criteria for the neighbor cell measurements as below.

In some embodiments, if no detectable cell is currently identified on the satellite currently being measured, the first apparatus 110 is required to start measuring the new higher ranked satellite immediately (after some processing time required for retuning).

In some other embodiments, if a detectable cell is currently identified on the satellite currently being measured, the first apparatus 110 is required to start measuring the new higher ranked satellite within a [K1*T_{detect}] (which may also be referred to as a second time interval) plus the processing time required for retuning, where K1 is a network configured parameter.

It is also possible that first apparatus 110 selects a high priority satellite, but it cannot identify a cell (no cell above the detectable levels), in this case the first apparatus 110 is also required to stop measuring the higher priority satellite and measure towards a lower priority satellite if no detectable cell is identified within [K2*T_{detect}] (which may also be referred to as a third time interval), where K2 is a network configured parameter.

In this solution of the present disclosure, a method is proposed to perform prioritization of the neighbor satellites to be chosen for UE measurements and how to deal with the measurement requirements and the “switch” of measurements when the UE has to change the satellite to be measured (e.g., due to satellite movement or occurrence of radio blocking).

The importance to define a method resides on the fact that the UE must be capable of detecting and evaluating neighbor cells within a time constraint defined in specification. This time constraint currently varies with the number of satellites being measured (including the serving satellite). Therefore, even if the UE has the capability to measure across several (more than 2) satellites, the method described here applies, with the adaptation needed.

In some embodiments, the UE will prioritize satellites first by their availability when the neighbor cell measurements are triggered. Moreover, in certain conditions the UE might skip the measurements across a neighbor satellite if a higher priority neighbor satellite is soon to become available.

Then, the UE may follow a priority across satellites to be implemented by the network. If no indication of satellite priority is provided, the UE might choose the satellite which is broadcasting the cell with highest priority (according to frequency layer prioritization) across the cells to be measured by the UE, when the UE can make the distinction between PCI lists in the different satellites.

When no priority is clearly provided to the UE, or there is a “tie” between priority levels, the UE will choose a secondary method to prioritization, such as based on location/distance/direction of movement, location/distance at the end of a time window, available frequencies on each satellite and/or expected time of stay in the cell.

Finally, when the UE has chosen a cell according to the priority rules, but no cell above the detectable level is found within a given period of time, the UE shall stop measurements towards this satellite and initiate measurements in the next satellite on the list. It is also possible that the UE may reevaluate the criteria if a new satellite is available. Likewise, the transition period for when a higher ranked satellite becomes available for measurements to this UE is also provided.

In this way, the number of satellites to be measured in the neighbor cell measurements can be limited and therefore the power saving of the UE may be further enhanced.

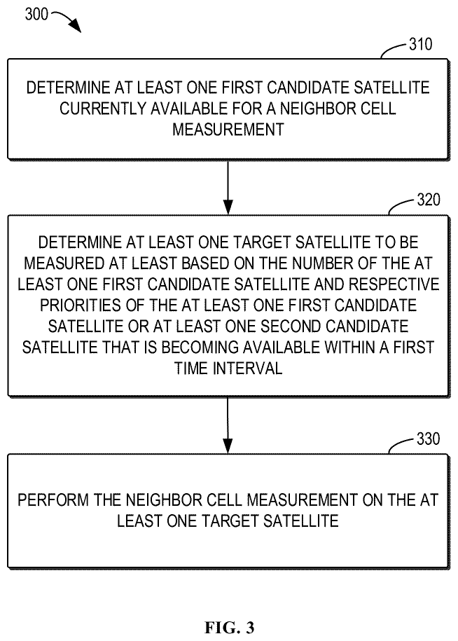

FIG. 3 shows a flowchart of an example method 300 implemented at a first device in accordance with some example embodiments of the present disclosure. For the purpose of discussion, the method 300 will be described from the perspective of the first apparatus 110 in FIG. 1.

At block 310, the first apparatus 110 determines at least one first candidate satellite currently available for a neighbor cell measurement.

At block 320, the first apparatus 110 determines at least one target satellite to be measured in the neighbor cell measurement at least based on the number of the at least one first candidate satellite and respective priorities of the at least one first candidate satellite, or at least one second candidate satellite that is becoming available within a first time interval.

At block 330, the first apparatus 110 performs the neighbor cell measurement on the at least one target satellite.

In some example embodiments, the first apparatus 110 may determine whether the at least one second candidate satellite is becoming available within the first time interval, wherein the at least one second candidate satellite has respective priorities higher than a priority of the first candidate satellite; and in accordance with a determination that the at least one second candidate satellite is becoming available within the first time interval, suspending the neighbor cell measurement until the at least one second candidate satellite becomes available.

In some example embodiments, in accordance with a determination that no second candidate satellite is becoming available within the first time interval, the first apparatus 110 may perform the neighbor cell measurement on the single first candidate satellite.

In some example embodiments, the first apparatus 110 may determine whether respective priorities assigned to the plurality of first candidate satellites is different. In accordance with a determination that the respective priorities assigned to the plurality of first candidate satellites is different, the first apparatus 110 may select from the plurality of first candidate satellites, the at least one target satellites to be measured based on a ranking of respective priorities of the plurality of first candidate satellites.

In some example embodiments, in accordance with a determination that at least two first candidate satellites in the plurality of first candidate satellites have a highest and equal priority, the first apparatus 110 may select from the plurality of first candidate satellites, one or more first candidate satellites, associated with a cell having a priority higher than priority levels of cells on the other first candidate satellites, as the at least one target satellite to be measured.

In some example embodiments, the first apparatus 110 may determine an association between the cell and the one or more first candidate satellites based on respective PCIs of the one or more first candidate satellites.

In some example embodiments, in accordance with a determination that at least two first candidate satellites in the plurality of first candidate satellites have a highest and equal priority, the first apparatus 110 may select the at least one target satellite to be measured from the plurality of first candidate satellites based on information comprising at least one of the following: location information of the first apparatus and the plurality of first candidate satellites, respective available frequencies in each of the plurality of first candidate satellites, respective periods within which the plurality of first candidate satellites is available for the first apparatus.

In some example embodiments, the location information comprises at least one of the following: respective locations of the first apparatus and the plurality of first candidate satellites currently or at the end of the first time interval, respective distances between the first apparatus and the plurality of first candidate satellites currently or at the end of the first time interval, or respective movement directions of the plurality of first candidate satellites with respect to the first apparatus.

In some example embodiments, tin accordance with a determination that no detectable cell is identified based on the neighbor cell measurement on the at least one target satellite, the first apparatus 110 may perform a further neighbor cell measurement on one or more further candidate satellites having higher priorities than the at least one target satellite after a required retuning time interval.

In some example embodiments, in accordance with a determination that there are one or more further candidate satellites having higher priorities than the at least one target satellite, the first apparatus 110 may perform a further neighbor cell measurement on the one or more further candidate cells within a second time interval regardless of whether a detectable cell is identified.

In some example embodiments, in accordance with a determination that no detectable cell is identified based on the neighbor cell measurement on the at least one target satellite within a third time interval, the first apparatus 110 may perform a further neighbor cell measurement on one or more further candidate satellites having lower priorities than the at least one target satellite.

In some example embodiments, the respective priorities are indicated via an signaling or an order of at least one candidate satellite listed in a configuration.

In some example embodiments, a first apparatus is capable of performing any of the method 300 (for example, the first apparatus 110 in FIG. 1 may comprise means for performing the respective operations of the method 300. The means may be implemented in any suitable form. For example, the means may be implemented in a circuitry or software module. The first apparatus may be implemented as or included in the first apparatus 110 in FIG. 1.

In some example embodiments, the first apparatus comprises means for determining at least one first candidate satellite currently available for a neighbor cell measurement; means for determining at least one target satellite to be measured in the neighbor cell measurement at least based on the number of the at least one first candidate satellite and respective priorities of the at least one first candidate satellite, or at least one second candidate satellite that is becoming available within a first time interval; and means for performing the neighbor cell measurement on the at least one target satellite.

In some example embodiments, the at least one first candidate satellite comprises a first candidate satellite, and wherein the first apparatus further comprises: means for determining whether the at least one second candidate satellite is becoming available within the first time interval, wherein the at least one second candidate satellite has respective priorities higher than a priority of the first candidate satellite; and means for in accordance with a determination that the at least one second candidate satellite is becoming available within the first time interval, suspending the neighbor cell measurement until the at least one second candidate satellite becomes available.

In some example embodiments, the first apparatus further comprises: means for in accordance with a determination that no second candidate satellite is becoming available within the first time interval, performing the neighbor cell measurement on the single first candidate satellite.

In some example embodiments, the at least one first candidate satellite comprises a plurality of first candidate satellites, and wherein the first apparatus further comprises: means for determining whether respective priorities assigned to the plurality of first candidate satellites is different; and means for in accordance with a determination that the respective priorities assigned to the plurality of first candidate satellites is different, selecting, from the plurality of first candidate satellites, the at least one target satellites to be measured based on a ranking of respective priorities of the plurality of first candidate satellites.

In some example embodiments, the first apparatus further comprises: means for in accordance with a determination that at least two first candidate satellites in the plurality of first candidate satellites have a highest and equal priority, selecting, from the plurality of first candidate satellites, one or more first candidate satellites, associated with a cell having a priority higher than priority levels of cells on the other first candidate satellites, as the at least one target satellite to be measured.

In some example embodiments, the first apparatus further comprises: means for determining an association between the cell and the one or more first candidate satellites based on respective PCIs of the one or more first candidate satellites.

In some example embodiments, the first apparatus further comprises: means for in accordance with a determination that at least two first candidate satellites in the plurality of first candidate satellites have a highest and equal priority, selecting the at least one target satellite to be measured from the plurality of first candidate satellites based on information comprising at least one of the following: means for location information of the first apparatus and the plurality of first candidate satellites, means for respective available frequencies in each of the plurality of first candidate satellites, means for respective periods within which the plurality of first candidate satellites is available for the first apparatus.

In some example embodiments, the location information comprises at least one of the following: means for respective locations of the first apparatus and the plurality of first candidate satellites currently or at the end of the first time interval, means for respective distances between the first apparatus and the plurality of first candidate satellites currently or at the end of the first time interval, or means for respective movement directions of the plurality of first candidate satellites with respect to the first apparatus.

In some example embodiments, the first apparatus further comprises: means for in accordance with a determination that no detectable cell is identified based on the neighbor cell measurement on the at least one target satellite, performing a further neighbor cell measurement on one or more further candidate satellites having higher priorities than the at least one target satellite after a required retuning time interval.

In some example embodiments, the first apparatus further comprises: means for in accordance with a determination that there are one or more further candidate satellites having higher priorities than the at least one target satellite, performing a further neighbor cell measurement on the one or more further candidate cells within a second time interval regardless of whether a detectable cell is identified.

In some example embodiments, the first apparatus further comprises: means for in accordance with a determination that no detectable cell is identified based on the neighbor cell measurement on the at least one target satellite within a third time interval, performing a further neighbor cell measurement on one or more further candidate satellites having lower priorities than the at least one target satellite.

In some example embodiments, the respective priorities are indicated via an signaling or an order of at least one candidate satellite listed in a configuration.

In some example embodiments, the first apparatus further comprises means for performing other operations in some example embodiments of the method 300 or the first apparatus 110. In some example embodiments, the means comprises at least one processor; and at least one memory storing instructions that, when executed by the at least one processor, cause the performance of the first apparatus.

FIG. 4 is a simplified block diagram of a device 400 that is suitable for implementing example embodiments of the present disclosure. The device 400 may be provided to implement a communication device, for example, the first apparatus 110 as shown in FIG. 1. As shown, the device 400 includes one or more processors 410, one or more memories 420 coupled to the processor 410, and one or more communication modules 440 coupled to the processor 410.

The communication module 440 is for bidirectional communications. The communication module 440 has one or more communication interfaces to facilitate communication with one or more other modules or devices. The communication interfaces may represent any interface that is necessary for communication with other network elements. In some example embodiments, the communication module 440 may include at least one antenna.

The processor 410 may be of any type suitable to the local technical network and may include one or more of the following: general purpose computers, special purpose computers, microprocessors, digital signal processors (DSPs) and processors based on multicore processor architecture, as non-limiting examples. The device 400 may have multiple processors, such as an application specific integrated circuit chip that is slaved in time to a clock which synchronizes the main processor.

The memory 420 may include one or more non-volatile memories and one or more volatile memories. Examples of the non-volatile memories include, but are not limited to, a Read Only Memory (ROM) 424, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 422 and other volatile memories that will not last in the power-down duration.

A computer program 430 includes computer executable instructions that are executed by the associated processor 410. The instructions of the program 430 may include instructions for performing operations/acts of some example embodiments of the present disclosure. The program 430 may be stored in the memory, e.g., the ROM 424. The processor 410 may perform any suitable actions and processing by loading the program 430 into the RAM 422.

The example embodiments of the present disclosure may be implemented by means of the program 430 so that the device 400 may perform any process of the disclosure as discussed with reference to FIGS. 2-3. The example embodiments of the present disclosure may also be implemented by hardware or by a combination of software and hardware.

In some example embodiments, the program 430 may be tangibly contained in a computer readable medium which may be included in the device 400 (such as in the memory 420) or other storage devices that are accessible by the device 400. The device 400 may load the program 430 from the computer readable medium to the RAM 422 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

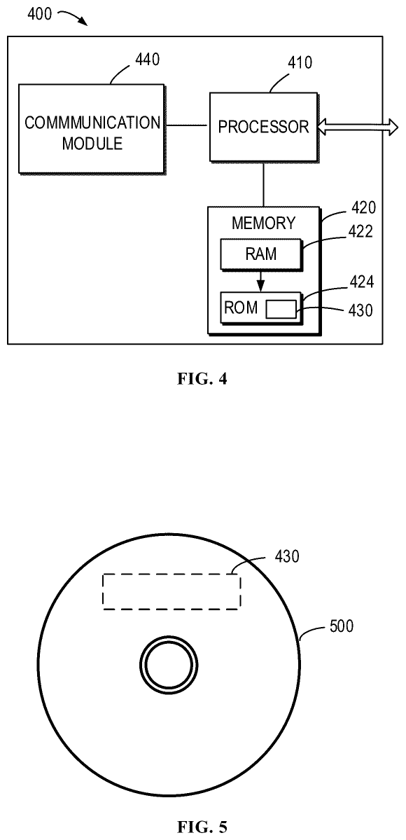

FIG. 5 shows an example of the computer readable medium 500 which may be in form of CD, DVD or other optical storage disk. The computer readable medium 500 has the program 430 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-15. (canceled)

16. A first apparatus comprising:
at least one processor; and
at least one memory storing instructions that, when executed by the at least one processor, cause the first apparatus at least to:
determine at least one first candidate satellite currently available for a neighbor cell measurement;
determine at least one target satellite to be measured in the neighbor cell measurement at least based on the number of the at least one first candidate satellite and respective priorities of:
the at least one first candidate satellite, or
at least one second candidate satellite that is becoming available within a first time interval; and
perform the neighbor cell measurement on the at least one target satellite.

17. The first apparatus of claim 16, wherein the at least one first candidate satellite comprises a first candidate satellite, and wherein the first apparatus is caused to:
determine whether the at least one second candidate satellite is becoming available within the first time interval, wherein the at least one second candidate satellite has respective priorities higher than a priority of the first candidate satellite; and
in accordance with a determination that the at least one second candidate satellite is becoming available within the first time interval, suspend the neighbor cell measurement until the at least one second candidate satellite becomes available.

18. The first apparatus of claim 17, wherein the first apparatus is caused to:
in accordance with a determination that no second candidate satellite is becoming available within the first time interval, perform the neighbor cell measurement on the single first candidate satellite.

19. The first apparatus of claim 16, wherein the at least one first candidate satellite comprises a plurality of first candidate satellites, and wherein the first apparatus is caused to:
determine whether respective priorities assigned to the plurality of first candidate satellites is different; and
in accordance with a determination that the respective priorities assigned to the plurality of first candidate satellites is different, select, from the plurality of first candidate satellites, the at least one target satellites to be measured based on a ranking of respective priorities of the plurality of first candidate satellites.

20. The first apparatus of claim 19, wherein the first apparatus is caused to:
in accordance with a determination that at least two first candidate satellites in the plurality of first candidate satellites have a highest and equal priority, select, from the plurality of first candidate satellites, one or more first candidate satellites, associated with a cell having a priority higher than priority levels of cells on the other first candidate satellites, as the at least one target satellite to be measured.

21. The first apparatus of claim 20, wherein the first apparatus is caused to:
determine an association between the cell and the one or more first candidate satellites based on respective physical cell identifiers, PCIs of the one or more first candidate satellites.

22. The first apparatus of claim 19, wherein the first apparatus is caused to:
in accordance with a determination that at least two first candidate satellites in the plurality of first candidate satellites have a highest and equal priority, select the at least one target satellite to be measured from the plurality of first candidate satellites based on information comprising at least one of the following:
location information of the first apparatus and the plurality of first candidate satellites,
respective available frequencies in each of the plurality of first candidate satellites,
respective periods within which the plurality of first candidate satellites is available for the first apparatus.

23. The first apparatus of claim 22, wherein the location information comprises at least one of the following:
respective locations of the first apparatus and the plurality of first candidate satellites currently or at the end of the first time interval,
respective distances between the first apparatus and the plurality of first candidate satellites currently or at the end of the first time interval, or
respective movement directions of the plurality of first candidate satellites with respect to the first apparatus.

24. The first apparatus of claim 16, wherein the first apparatus is further caused to:
in accordance with a determination that no detectable cell is identified based on the neighbor cell measurement on the at least one target satellite, perform a further neighbor cell measurement on one or more further candidate satellites having higher priorities than the at least one target satellite after a required retuning time interval.

25. The first apparatus of claim 16, wherein the first apparatus is further caused to:
in accordance with a determination that there are one or more further candidate satellites having higher priorities than the at least one target satellite, perform a further neighbor cell measurement on the one or more further candidate cells within a second time interval regardless of whether a detectable cell is identified.

26. The first apparatus of claim 16, wherein the first apparatus is further caused to:
in accordance with a determination that no detectable cell is identified based on the neighbor cell measurement on the at least one target satellite within a third time interval, perform a further neighbor cell measurement on one or more further candidate satellites having lower priorities than the at least one target satellite.

27. The first apparatus of claim 16, wherein the respective priorities are indicated via an signaling or an order of at least one candidate satellite listed in a configuration.

28. A method comprising:
determining at least one first candidate satellite currently available for a neighbor cell measurement;
determining at least one target satellite to be measured in the neighbor cell measurement at least based on the number of the at least one first candidate satellite and respective priorities of:
the at least one first candidate satellite, or
at least one second candidate satellite that is becoming available within a first time interval; and
performing the neighbor cell measurement on the at least one target satellite.

29. The method of claim 28 further comprising:
determining whether the at least one second candidate satellite is becoming available within the first time interval, wherein the at least one second candidate satellite has respective priorities higher than a priority of the first candidate satellite; and
in accordance with a determination that the at least one second candidate satellite is becoming available within the first time interval, suspending the neighbor cell measurement until the at least one second candidate satellite becomes available.

30. The method of claim 29 further comprising:
in accordance with a determination that no second candidate satellite is becoming available within the first time interval, performing the neighbor cell measurement on the single first candidate satellite.

31. The method of claim 28 further comprising:
determining whether respective priorities assigned to the plurality of first candidate satellites is different; and
in accordance with a determination that the respective priorities assigned to the plurality of first candidate satellites is different, selecting, from the plurality of first candidate satellites, the at least one target satellites to be measured based on a ranking of respective priorities of the plurality of first candidate satellites.

32. The method of claim 31 further comprising:
in accordance with a determination that at least two first candidate satellites in the plurality of first candidate satellites have a highest and equal priority, selecting, from the plurality of first candidate satellites, one or more first candidate satellites, associated with a cell having a priority higher than priority levels of cells on the other first candidate satellites, as the at least one target satellite to be measured.

33. The method of claim 32 further comprising:
determining an association between the cell and the one or more first candidate satellites based on respective physical cell identifiers, PCIs of the one or more first candidate satellites.

34. The method of claim 32 further comprising:
in accordance with a determination that at least two first candidate satellites in the plurality of first candidate satellites have a highest and equal priority, selecting the at least one target satellite to be measured from the plurality of first candidate satellites based on information comprising at least one of the following:
location information of the first apparatus and the plurality of first candidate satellites, respective available frequencies in each of the plurality of first candidate satellites, respective periods within which the plurality of first candidate satellites is available for the first apparatus.

35. A first apparatus comprising:
means for determining at least one first candidate satellite currently available for a neighbor cell measurement;
means for determining at least one target satellite to be measured in the neighbor cell measurement at least based on the number of the at least one first candidate satellite and respective priorities of:
the at least one first candidate satellite, or
at least one second candidate satellite that is becoming available within a first time interval; and
means for performing the neighbor cell measurement on the at least one target satellite.
